(19) United States
(12) Patent Application Publication
(10) Pub. No.: US 2012/0254615 A1
(43) Pub. Date: Oct. 4, 2012

(54) USING A DYNAMICALLY-GENERATED SYMMETRIC KEY TO ESTABLISH INTERNET PROTOCOL SECURITY FOR COMMUNICATIONS BETWEEN A MOBILE SUBSCRIBER AND A SUPPORTING WIRELESS COMMUNICATIONS NETWORK

(75) Inventors: Ding Ma, Hoffman Estates, IL (US); Mark G. Spiotta, Wheaton, IL (US)

(73) Assignee: MOTOROLA SOLUTIONS, INC., Schaumburg, IL (US)

(21) Appl. No.: 13/076,972

(22) Filed: Mar. 31, 2011

(51) Int. Cl. H04L 9/32

(52) U.S. Cl. 713/171; 713/168

(57) ABSTRACT

Embodiments provide a means for securing wireless network communications. A security association can be established between a mobile subscriber device (105) and an access router (125) of a wireless communications network (120), upon successful authentication of the mobile subscriber device (105). The security association can utilize a dynamically-generated IP security (IPsec) symmetric key (175) unique to the mobile subscriber device (105). Subsequent network communications between the mobile subscriber device (105) and the access router (125) can be secured using the IPsec symmetric key (175) to either directly authenticate and encrypt/decrypt or dynamically establish further security associations to authenticate and encrypt/decrypt the subsequent network communications (170). Securing of the network communications (175) can be performed as a substitute for or in addition to existing security measures of the wireless communications network (120).

### FIELD OF THE INVENTION

The invention relates generally to wireless communications security, and more particularly to using a dynamically-generated symmetric key to establish Internet Protocol security (IPsec) for communications between a mobile subscriber and an Internet Protocol Version 6 (IPv6)-supporting wireless communications network.

### BACKGROUND

The security plays a critical role in protecting the network communications of a wireless communications network; communications between a user's mobile subscriber device and the wireless communications network must be protected from unauthorized handling (i.e., spoofing or snooping). New improvements and/or approaches for securing network communications are always being developed, however, deployment, implementation, or adoption of these improvements or approaches often have overwhelming obstacles.

As an example, version six of the Internet Protocol (IPv6) supports the IP security (IPsec) protocol suite for authenticating and encrypting/decrypting message traffic. While IPsec would appear to be the logical choice to secure network communications, the reality of implementing IPsec configuration and policy synchronization between the wireless communications network and its astronomical quantity of mobile subscriber devices is prohibitive. Conventional approaches (i.e., public key infrastructure, pre-shared key) for establishing an IPsec security association utilize issued keys that require synchronization and/or additional manual support for distribution.

As a result, many wireless communications network disregard the use of IPsec between the access router (main access point to the network) and the mobile subscriber device; instead relying upon security implemented at the link layer and at each node in the path between the mobile subscriber device and the access router (i.e., hop-by-hop). Unfortunately, intermediate hops in the network path provide varying levels of protection, introducing a variety of security vulnerabilities to the network communications along that network path.

### SUMMARY

One embodiment of the disclosure can include a method for securing wireless network communications. Such a method can begin with the authentication of a mobile subscriber device by an access router of a wireless communications network. The wireless communications network can support the standards and protocols associated with an Internet Protocol (IP) of at least version six. The access router can act as a gateway for exchanges of network communications between the mobile subscriber device and the wireless communications network. In context of a wireless network, the term access router refers to a logical entity that may consist of several physical entities that provide at least routing, session control, and mobility management functionalities. Upon successful authentication of the mobile subscriber device to the wireless communications network, a security association can be established between the mobile subscriber device and the access router. The security association can utilize a dynamically-generated IP security (IPsec) symmetric key unique to the mobile subscriber device. Subsequent network communications between the mobile subscriber device and the access router can be secured using the IPsec security associations derived from this symmetric key to authenticate and encrypt/decrypt the subsequent network communications. Securing of the network communications can be performed as a substitute for or in addition to existing security measures of the wireless communications network.

Another embodiment of the disclosure can include a system for securing wireless network communications. Such a system can include a mobile subscriber device and a wireless communications network that includes a set of authentication handling components, an access router, and an IPsec manager. The mobile subscriber device can be capable of handling IPsec-secured network communications. The wireless communications network can be configured to exchange IPsec-secured communications with the mobile subscriber device. The set of authentication handling components can be configured to ascertain connectivity validity for the mobile subscriber device to access the wireless communications network. The access router can act as a gateway to the wireless communications network for exchanging IPsec-secured network communications with the mobile subscriber device having valid connectivity as ascertained by the set of authentication handling components. The IPsec manager can be configured to dynamically establish a unique security association between the mobile subscriber device and the access router. The security association can be used to secure network communications with the mobile subscriber device, creating IPsec-secured network communications.

Yet another embodiment of the disclosure can include a computer program product that includes a computer readable storage medium having embedded computer usable program code. The computer usable program code configured to acquire a primary security key generated by authentication handling components of a wireless communications network upon successful authentication of a mobile subscriber device. The primary security key can be unique to a communications session between the mobile subscriber device and the wireless communications network. The computer usable program code can be configured to dynamically generate an IPsec symmetric key from the primary security key in accordance with standard key generation algorithms and protocols. Then, the computer usable program code can be configured to obtain a unique identifier associated with the mobile subscriber device. The computer usable program code can then be configured to record a relationship between the obtained unique identifier and the generated IPsec symmetric key as a security association in a security association database of the wireless communications network. The security association can be used to secure network communications between the wireless communications network and the mobile subscriber device.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 illustrates a block diagram of a system that utilizes Internet Protocol security (IPsec) to secure network communications between a mobile subscriber device and the access router of an IPv6-supporting wireless communications network in accordance with embodiments of the inventive arrangements disclosed herein.

FIG. 2 shows a block diagram of a system for implementing IPsec to secure network communications in a Worldwide Interoperability for Microwave Access (WiMax) network in accordance with embodiments of the inventive arrangements disclosed herein.

FIG. 3 depicts a block diagram of a system for implementing IPsec to secure network communications in a 3GPP Long Term Evolution (LTE) network in accordance with embodiments of the inventive arrangements disclosed herein.

FIG. 4 is a flow chart of a method detailing a high-level overview for utilizing IPsec to secure network communications in an IPv6-supporting wireless communications network in accordance with embodiments of the inventive arrangements disclosed herein.

FIG. 5 shows an illustrated process flow depicting generation of the IPsec symmetric key in a WiMax network in accordance with embodiments of the inventive arrangements disclosed herein.

FIG. 6 shows an illustrated process flow depicting generation of the IPsec symmetric key in a LTE network in accordance with embodiments of the inventive arrangements disclosed herein.

### DETAILED DESCRIPTION OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Embodiments described herein address the problems associated with effectively and efficiently implementing IPsec policies to secure the network communications of a wireless communications network having a high volume of mobile subscriber devices. By utilizing existing generated security key materials, IPsec symmetric key can be dynamically created and used to establish an IPsec security association on a per-device basis. The mobile subscriber device, which is also provided with these existing security key materials, can be prompted to independently generate the IPsec symmetric key. The IPsec symmetric key can then be used to secure network communications exchanged between the wireless communications network and the mobile subscriber device.

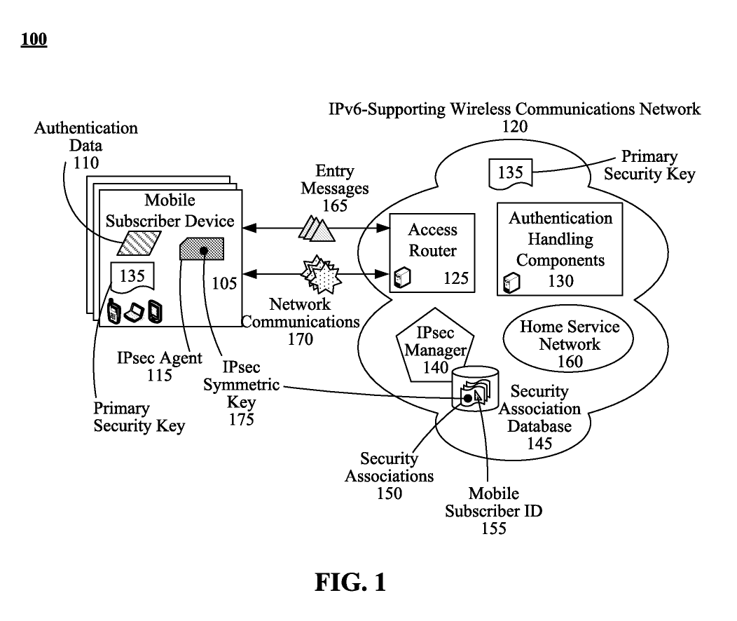

FIG. 1 illustrates a block diagram of a system 100 that utilizes IPsec to secure network communications 170 between a mobile subscriber device 105 and the access router 125 of an IPv6-supporting wireless communications network 120 in accordance with embodiments of the inventive arrangements disclosed herein. In system 100, an IPsec symmetric key 175 can be generated by the IPsec manager 140 and used to establish a security association 150 to secure network communications 170 between the mobile subscriber device 105 and the IPv6-supporting wireless communications network 120.

The IPv6-supporting wireless communications network 120, herein referred to as the wireless communications network 120, can represent the hardware and/or software components required for the wireless transmission of network communications 170 and the support of device addressing in accordance with IPv6. The wireless communications network 120 can support a variety of functional components and/or configurations of those components. However, only those functional components relevant to the present invention are illustrated in the Figures.

Wireless communications network 120 can include an access router 125, authentication handling components 130, an IPsec manager 140, and a home service network 160. The access router 125 can represent the hardware and/or software components required to handle incoming/outgoing network communications 170 for the wireless communications network 120. In one embodiment, the access router 125 can be a logical entity consisting of one or more physical entities that in aggregate provide at least routing, session control, and mobility management functionalities. Depending upon the specific implementation of the wireless communications network 120, the access router 125 can be configured to encrypt/decrypt network communications 170, route incoming messages to other internal components, trigger other network functions, and the like.

For example, when a mobile subscriber device 105 enters the coverage area of the wireless communications network 120, the access router 125 can exchange entry messages 165 with the mobile subscriber device 105. The entry messages 165 can represent a series of request and responses between the mobile subscriber device 105 and the access router 125 in which it can be determined if the mobile subscriber device 105 is to be allowed access to the wireless communications network 120.

Typically, the mobile subscriber device 105 can provide the access router 125 one or more entry messages 165 containing authentication data 110. The authentication data 110 can represent user and/or device-specific data that authorizes the use of the wireless communications network 120 by the mobile subscriber device 105.

For example, authentication data 110 can represent the International Mobile Subscriber Identity (IMSI) stored in the universal subscriber identity module (USIM) or SIM card of the mobile subscriber device 105.

The access router 125 can reply and route the entry messages 165 to the authentication handling components 130 and/or the home service network 160. The authentication handling components 130 can represent the hardware and/or software components used to authenticate the mobile subscriber device 105 to the wireless communications network 120. The type of authentication performed and the physical location of the authentication handling components 130 within the wireless communications network 120 can vary depending upon the specific implementation of the wireless communications network 120, as will be discussed in subsequent Figures.

The home service network 160 can represent the service providing entity to which the mobile subscriber device 105 subscribes (i.e., pays for network access). In many configurations of wireless communications networks 120, various business entities can own different portions of the overall geographic network. Service agreements between the various business entities can provide seamless service, however, additional costs can be incurred (i.e., roaming charges).

Thus, the access router 125 and/or authentication handling components 130 will often contact the home service network 160 of the mobile subscriber device 105 to determine not only if the mobile subscriber device 105 is to be provided access, but also any additional restrictions and/or fees for the mobile subscriber device 105.

After the successful authentication of the mobile subscriber device 105 to the wireless communications network 120, the authentication handling components 130 and/or home service network 160 and the mobile subscriber device can independently generate a common primary security key 135 for the mobile subscriber device's 105 communications session. The primary security key 135 will never be exchanged between the mobile subscriber device 105 and the wireless communications network 120. Additional uses of the primary security key 135 can vary based upon the specific implementation of the wireless communications network 120.

The IPsec manager 140 can use the primary security key 135 to establish a security association 150 to secure the network communications 170 between the access router 125 and mobile subscriber device 105. In this embodiment, the security association 150 can represent a relationship between a unique mobile subscriber identifier 155 for the mobile subscriber device 105 and an IPsec symmetric key 175.

The mobile subscriber identifier 155 can be a data value that uniquely identifies the mobile subscriber device 105; not a user of the mobile subscriber device 105 since a user can utilize multiple mobile subscriber devices 105 to simultaneously access the wireless communications network 120. The data value used as the mobile subscriber identifier 155 can vary depending upon the type of mobile subscriber device 105 and/or the specific implementation of the IPsec manager 140.

For example, the IMSI or Media Access Control (MAC) address of the mobile subscriber device 105 can be used as the mobile subscriber identifier 155.

The IPsec symmetric key 175 represent a unique security key generated by the IPsec manager 140 using an accepted key generation algorithm and/or protocol. Generation of the IPsec symmetric key 175 can use all or a portion of the primary security key 135.

The security association 150 can be stored in a security association database 145 for future reference. The security association 150 for a mobile subscriber device 105 can be removed from the security association database 145 when the mobile subscriber device 105 is no longer connected to the wireless communications network 120. Thus, a new security association 150 can be dynamically generated if the mobile subscriber device 105 reconnects to the wireless communications network 120 at a later time.

It should also be noted that the functional components illustrated in the wireless communications network 120 of system 100 can be logically combined or separated among physical components depending upon the type of wireless communications network 120, implementation of the functional components, and/or the configuration of the wireless communications network 120.

For example, in one embodiment, elements of the authentication handling components 130 can independently operate from the access router 125 and/or home service network 160. In another embodiment, the IPsec manager 140 can operate from the access router 125.

The use of a symmetric security key requires that both the sender and receiver use the same security key to encrypt/decrypt network communications 170. In the preferred embodiment of the present invention, as shown in system 100, the mobile subscriber device 105 can include an IPsec agent 115 that can be configured to independently generate the IPsec symmetric key 175 using the same algorithm as the IPsec manager 140 (the mobile subscriber device 105 already possesses the same primary security key 135, which it generated independently during its authentication with the wireless communication network 120).

The mobile subscriber device 105 can represent a variety of portable electronic computing devices capable of connecting to the wireless communications network 120 for the purposes of communication and supporting operation of the IPsec agent 115. Examples of mobile subscriber devices 105 can include, but are not limited to, radios, laptop computers, notebook computers, mobile phones, smartphones, personal data assistants (PDAs), and the like.

The mobile subscriber device 105 can include a variety of functional components required for the transmission of network communications 170 like software applications and a transceiver. However, only elements of particular relevance to the present invention are depicted in the Figures.

The IPsec agent 115 can represent a software application, IPsec protocol stack or set of IPsec algorithms that can be executed to produce the IPsec symmetric key 175. The instruction to generate the IPsec symmetric key 175 can be sent to the mobile subscriber device 105 from the access router 125 as part of the authentication of the mobile subscriber device 105 to the wireless communications network 120.

It should be noted that the independent generation of the IPsec symmetric key 175 can further increase security by not requiring transmission of the IPsec symmetric key 175 from the wireless communications network 120 to the mobile subscriber device 105, which could be intercepted and used by a third-party to access the network communications 170 of the mobile subscriber device's 105 session.

Once both the mobile subscriber device 105 and the wireless communications network 120 have generated the IPsec symmetric key 175, subsequent network communications 170 exchanged between the device 105 and network 120 can be authenticated and encrypted/decrypted using the IPsec Security Associations derived through an key exchange protocol (such as IKE—Internet Key Exchange) secured with the IPsec symmetric key 175.

For example, once the mobile subscriber device 105 successfully authenticates, the access router 125 can send a message called a router advertisement to the mobile subscriber device 105. The router advertisement can contain important information for the mobile subscriber device 105, such as IP addressing method, IP lifetime, and the IP address prefix.

In a conventional wireless communications network, the security of the router advertisement can fall upon the individual security measures and/or protocols established at each node of the wireless communications network that the router advertisement passes through. That is, a singular, comprehensive security practice does not exist that ensures the security of the router advertisement from the access router to the mobile subscriber device.

As such, the router advertisement can be subject to various vulnerabilities along the traveled network path. For example, the router advertisement can be intercepted by a malicious entity and replaced with a fake router advertisement that connects the mobile subscriber device to an unsecure wireless communications network where data sent by the mobile subscriber device can be collected and used without authorization. Interception of the router advertisement can occur at any intermediate node of the wireless communications network whose security measures are insufficient or have been compromised or can occur while the router advertisement in-transit (i.e., over-the-air capture).

Using the embodiment illustrated in system 100, the router advertisement can be securely delivered to the mobile subscriber device 105 using the IPsec Security Associations derived through IKE secured with the IPsec symmetric key 175. Should the router advertisement be intercepted at any node or in-transit, a malicious entity cannot readily decipher the message without the knowledge of the IPsec symmetric key 175 and the IPsec Security Associations derived using the IPsec symmetric key 175. Also, production of counterfeit router advertisements or other network communications 170 can be minimized, since a counterfeiting entity cannot encrypt the message with the expected the IPsec Security Associations derived using the IPsec symmetric key 175.

It is important to emphasize that the approach illustrated in system 100 can be implemented within conventional wireless communications network 120 with minimal restructuring—IPv6 already supports IPsec and the IPsec symmetric key 175 is generated from the primary security key 135 that is already produced by conventional authentication procedures.

Further, since the IPsec symmetric key 175 is generated dynamically, the management problems often encountered with other key-based security techniques can be avoided. For example, this approach can avoid the overhead associated with distribution of a pre-shared key or certificate among a high volume of mobile subscriber devices 105.

Additionally, since each security association 150 is related to a single mobile subscriber device 105, any problem encountered with regards to the use of the security association 150 can be limited to that specific mobile subscriber device 105 and not all mobile subscriber devices 105. In a conventional wireless communications network 120 that relies upon IPsec hop-by-hop, an IPsec problem that occurs between the mobile subscriber device 105 and the access router 125 can impact all mobile subscriber devices 105.

The overhead incurred by the implementation of IPsec in conventional wireless communications networks 120 can result in the application of IPsec to only network communications 170 of specific types. This approach can reduce the overhead to allow all network communications 170 between the mobile subscriber device 105 and access router 125 to benefit from IPsec.

As used herein, the presented security association database 145 can be a physical or virtual storage space configured to store digital information. The security association database 145 can be physically implemented within any type of hardware including, but not limited to, a magnetic disk, an optical disk, a semiconductor memory, a digitally encoded plastic memory, a holographic memory, or any other recording medium. The security association database 145 can be a stand-alone storage unit as well as a storage unit formed from a plurality of physical devices. Additionally, information can be stored within security association database 145 in a variety of manners. Further, security association database 145 can utilize one or more encryption mechanisms to protect stored information from unauthorized access.

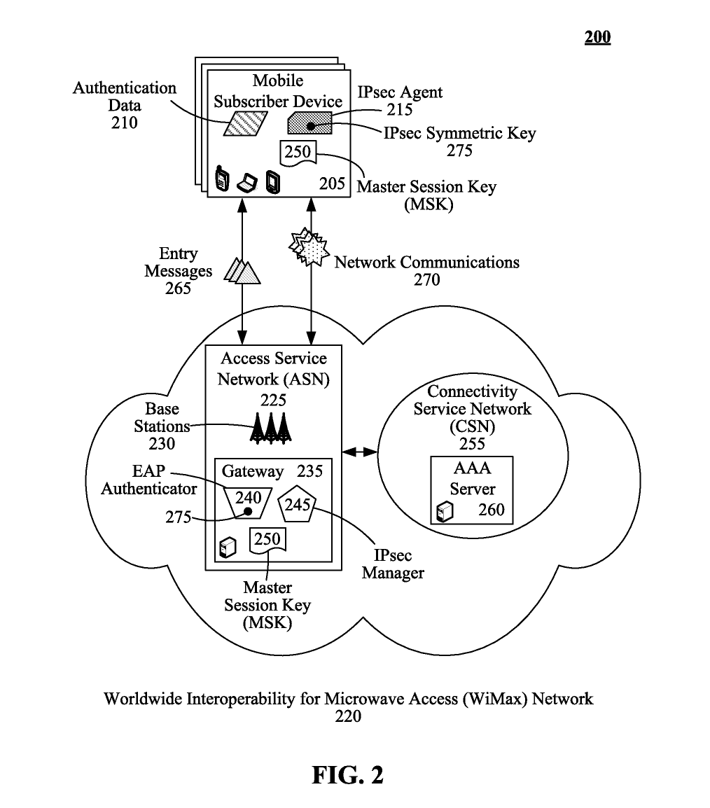

FIG. 2 shows a block diagram of a system 200 for implementing IPsec to secure network communications 270 in a Worldwide Interoperability for Microwave Access (WiMax) network 220 in accordance with embodiments of the inventive arrangements disclosed herein. System 200 can represent a specific embodiment of system 100 of FIG. 1.

In system 200, network communications 270 between a mobile subscriber device 205 and a WiMax network 220 can be secured using the IPsec approach as described in system 100 of FIG. 1. Basic operation of a WiMax network 220 is known by those skilled in the art and will not be discussed in-depth herein, except where warranted.

The mobile subscriber device 205 can request access to the WiMax network 220 by submitting authentication data 210 and/or a series of entry messages 265. The entry messages 265 can be received by the access service network (ASN) 225. The ASN 225 can provide functionality for the transmission of network communications 270 to/from the mobile subscriber device 205 and/or the connectivity service network (CSN) 255.

The CSN 255 can correspond to the home service network 160 of system 100. The CSN 255 can represent the business entity with which the mobile subscriber device 205 has a service contract. The functions of the CSN 255 can include IP address allocation, subscriber billing, policy control, quality of service management, and the like.

As such, the mobile subscriber device 205 can authenticate to the CSN 255 in addition to the ASN 225 (i.e., the mobile subscriber device 205 is a valid subscriber of the CSN 255 and the ASN 225 has a valid service agreement with the CSN 255). Authentication of the mobile subscriber device 205 can be performed by an Authentication, Authorization, and Accounting (AAA) server 260. The AAA server 260 can verify the authentication data 210 of the mobile subscriber device 205 with respect to the CSN 255 utilizing a variety of mechanisms dependent upon implementation.

The ASN 225 can include multiple base stations 230 as well as multiple gateways 235. A base station 230 can represent the hardware and/or software components necessary to enable wireless network communications 270 (i.e., a cell tower or radio tower). A gateway 235 can represent the primary access point for the mobile subscriber device 205 like the access router 125 of system 100. Security functions of the gateway 235 can be supported by the Extensible Authentication Protocol (EAP) authenticator 240 and the IPsec manager 245.

The EAP authenticator 240 can represent the hardware and/or software components necessary to implement the EAP relay function for one or more EAP authentication methods (e.g., EAP-TLS, EAP-AKA, EAP-TTLS, etc.). The mutual authentication of the mobile subscriber device 205 and the AAA server 260 relayed by the EAP authenticator 240 can produce the Master Session Key (MSK) 250, which can correspond to the primary security key 135 of system 100. The mobile subscriber device 205 and the AAA server 260 independently generate the MSK 250 after successful authentication. The AAA server 260 then sends the MSK 250 to the EAP authenticator 240 through the pre-established secure connection between the AAA server 260 and the EAP authenticator 240.

The MSK 250 (all or a portion of it) can then be used by the IPsec manager 245 to derive the IPsec symmetric key 275 which is used to protect the key exchange to establish IPsec security associations between the mobile subscriber device 205 and the gateway 235. The mobile subscriber device 205 can be configured to support IPsec by means of the IPsec agent 215. The IPsec agent 215 can be used to independently generate the IPsec symmetric key 275 used by the gateway 235 to perform secure key exchange in order to establish IPsec security associations to authenticate, encrypt, and decrypt network communications 270.

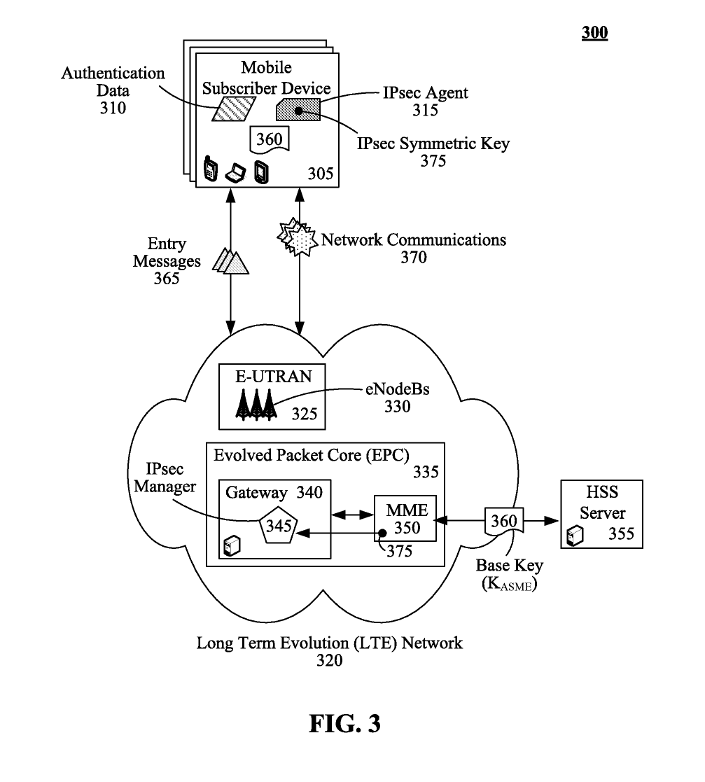

FIG. 3 depicts a block diagram of a system 300 for implementing IPsec to secure network communications 370 in a 3GPP Long Term Evolution (LTE) network 320 in accordance with embodiments of the inventive arrangements disclosed herein. System 300 can represent a specific embodiment of system 100 of FIG. 1.

In system 300, network communications 370 between a mobile subscriber device 305 and a 3^{rd} Generation Partnership Project (3GPP) LTE network 320, herein referred to as a LTE network 320, can be secured using the IPsec approach as described in system 100 of FIG. 1. Basic operation of a LTE network 320 is known by those skilled in the art and will not be discussed in-depth herein, except where warranted.

The mobile subscriber device 305 can request access to the LTE network 320 by submitting authentication data 310 and/or a series of entry messages 365. The entry messages 365 can be received and/or relayed by eNodeBs 330 of the Evolved UMTS Terrestrial Access Network (E-UTRAN) 325. Like the base station 230 of the ASN 225, an eNodeB 330 can provide functionality for the transmission of network communications 370 between the mobile subscriber device 305 and the Evolved Packet Core (EPC) 335.

The EPC 335 can represent the core network architecture of the LTE network 320. The EPC 335 can include a gateway 340, also called the serving gateway, and a mobility management entity (MME) 350. The gateway 340 can represent the primary data access point for the mobile subscriber device 305 like the access router 125 of system 100. The gateway 340 can support function of the IPsec manager 345.

The MME 350 can represent the hardware and/or software components required to support subscriber and session management functions, such as initiating authentication of the mobile subscriber device 305. The MME 350 can communicate with the Home Subscriber Server (HSS) 355 to determine the authenticity of the mobile subscriber device's 305 authentication data 310.

The HSS server 355 can generate a base key (K_{ASME}) 360, which can correspond to the primary security key 135 of system 100, to be used by the LTE network 320 for the mobile subscriber device 305. The HSS server 355 can securely convey the K_{ASME} 360 to the MME 350. And the mobile subscriber device 305 can independently generate the same K_{ASME} 360.

The MME 350 can then generate the IPsec Symmetric Key 375 using the K_{ASME} 360 and provide the IPsec Symmetric Key 375 to the IPsec manager 345 for establishing IPsec between the mobile subscriber device 305 and the gateway 340. The mobile subscriber device 305 can be configured to support IPsec by means of the IPsec agent 315. The mobile subscriber device 305 can independently generate the IPsec symmetric key 375 using the K_{ASME} 360 and provide the IPsec symmetric key 375 to the IPsec agent 315.

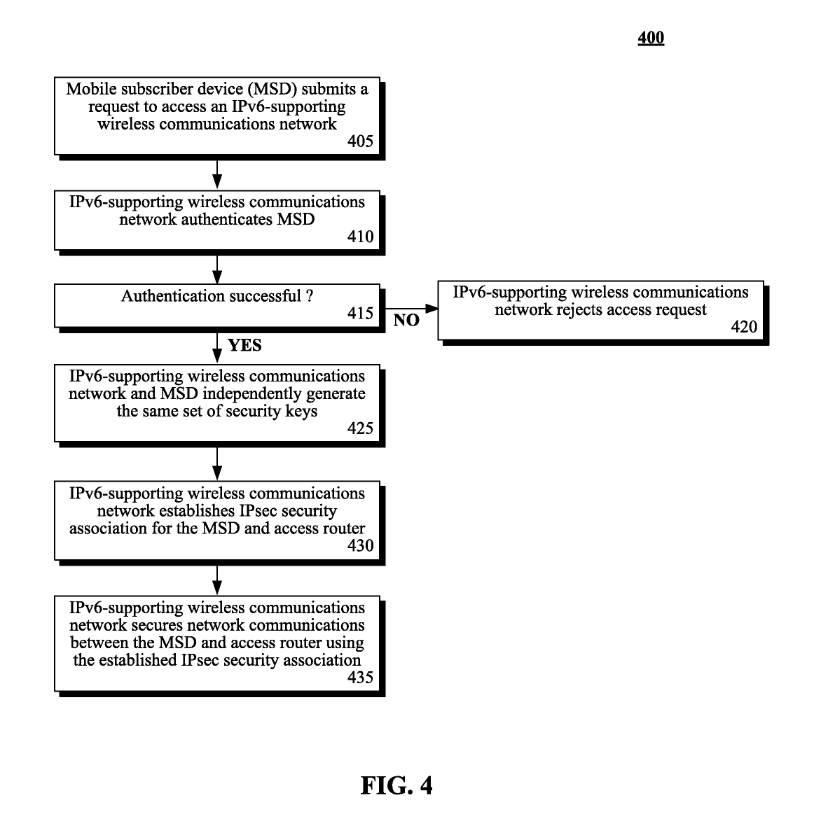

FIG. 4 is a flow chart of a method 400 detailing a high-level overview for utilizing IPsec to secure network communications in an IPv6-supporting wireless communications network in accordance with embodiments of the inventive arrangements disclosed herein. Method 400 can be performed within the contexts of systems 100, 200, and/or 300.

Method 400 can begin in step 405 where a mobile subscriber device can submit a request to access an IPv6-supporting wireless communications network, herein referred to as the wireless communications network. The wireless communications network can authenticate the mobile subscriber device in step 410.

In step 415, it can be determined if the mobile subscriber device has been successfully authenticated. When authentication of the mobile subscriber device is unsuccessful, step 420 can execute where the wireless communications network rejects the access request of the mobile subscriber device.

When authentication of the mobile subscriber device is successful, the wireless communications network can generate security keys for the mobile subscriber device in step 425. The security keys generated in step 425 can include the primary security key as well as the IPsec symmetric key. The mobile subscriber device can independently generate the same set of security keys after the successful authentication.

In step 430, the wireless communications network can establish an IPsec security association for the mobile subscriber device and the access router of the wireless communications network. The wireless communications network can then secure network communications between the mobile subscriber device and access router using the established IPsec security association in step 435.

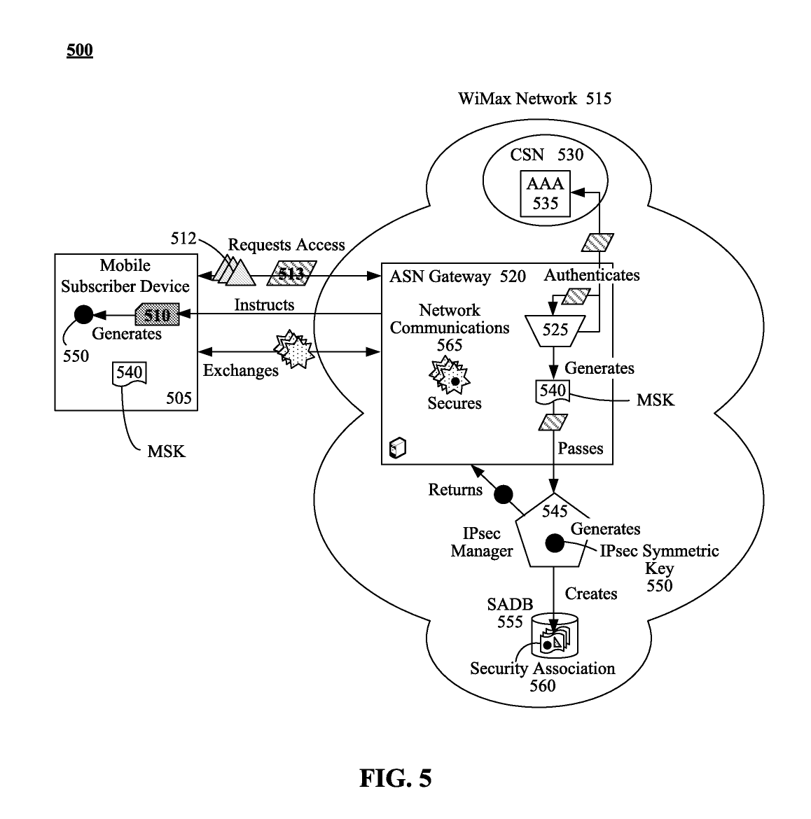

FIG. 5 shows an illustrated process flow 500 depicting generation of the IPsec symmetric key 550 in a WiMax network 515 in accordance with embodiments of the inventive arrangements disclosed herein. The steps of process flow 500 can be performed within the context of systems 100, 200, and/or in conjunction with method 400.

Process flow 500 can begin when the mobile subscriber device 505 requests access to the WiMax network 515. As part of requesting access, the mobile subscriber device 505 can exchange a series of entry messages 512 with the ASN gateway 520 as well as provide the ASN gateway 520 with authentication data 513.

The ASN gateway 520 can pass the authentication data 513 to the EAP authenticator 525, which relays the authentication data 513 to the AAA server 535 of the CSN 530 for authentication of the mobile subscriber device 505. The AAA server 535 also provides its own authentication data (similar to 513) to the mobile subscriber device 505 through the relay function provided by the EAP authenticator 525. Upon successful mutual authentication between the mobile subscriber device 505 and the AAA server 535, both the mobile subscriber device 505 and the AAA server 535 can independently generate the MSK 540 to be used for the session of the mobile subscriber device 505. The AAA server 535 provides the MSK 540 to the EAP authenticator 525 through a pre-established secure connection.

The MSK 540 can then be passed to the IPsec manager 545. Additionally, the EAP authenticator 525 or ASN gateway 520 can also pass the authentication data 513 to the IPsec manager 545 at this time. Alternately, the IPsec manager 545 can request the authentication data 513 or a unique identifier for the mobile subscriber device 505 from the ASN gateway 520.

Using the MSK 540, the IPsec manager 545 can generate the IPsec symmetric key 550. The following equation can exemplify generation of the IPsec symmetric key (ISK) 550:

ISK=Dot16KDF(SUBSTR(MSK,320,192),MAC Address|“IKE”,192),

where Dot16KDF is a key generation algorithm; SUBSTR(MSK,320,192) defines input key material as a substring of a Master Session Key (MSK) starting at a character located at place three hundred and twenty for a length of one hundred and ninety two characters; MAC Address is a unique Media Access Control (MAC) identifier of the mobile subscriber device; MAC Address|“IKE” represent a string for altering output of the key generation algorithm; and one hundred and ninety two defining a length of the IPsec symmetric key to be generated by the key generation algorithm. Specifics of the above algorithm can vary from implementation-to-implementation and derivatives and alternatives are contemplated.

As shown, the equation can utilize the Dot16KDF key generation algorithm, as defined in IEEE 802.16e-2005. The parameters to this key generation algorithm can include input key material, SUBSTR(MSK,320,192), a string for altering output, MAC Address|“IKE”, and the length of the key to be generated, 192. The input key material can be represented as a substring of the MSK 540.

In current implementations of WiMax networks 515, components of the WiMax network 515 can utilize the first 320-bits of the MSK 540, which has a total length of 512-bits. From these 320-bits, 160-bits can be used to as the pairwise master key (PMK) and the remaining 160-bits can be used to create an EAP integrity key (EIK) for the communications session of the mobile subscriber device 505.

As such, the remaining 192 bits of the MSK 540 that are currently unused by elements of the WiMax network 515 can be utilized by the IPsec manager 545 to as the basis of the IPsec symmetric key 550. Thus, a substring function can be performed on the MSK 540 that extracts the portion of the MSK 540 that starts at the 320^{th}-bit and continues for a length of 192-bits.

The output altering string can act like the seed value of a random number generating function; it can provide a means for interjecting a second layer of variability into the function to enhance the strength of the cryptography. The Media Access Control (MAC) address of the mobile subscriber device 505 can be used in concatenation with the string “IKE”. Therefore, the variability of the function can be further varied on a per device 505 basis.

The last parameter can simply express the length, 192-bits, of the output, the IPsec symmetric key 550, that is to be produced by the key generation algorithm. So, if the function should generate an output string longer than 192-bits, the returned value of the function can be truncated to exactly 192-bits.

After generation of the IPsec symmetric key 550, the IPsec manager 545 can create the security association 560 for the mobile subscriber device 505 in the security association database (SADB) 555. Then, the IPsec manager 545 can return the IPsec symmetric key 550 to the ASN gateway 520.

In an alternate embodiment where the IPsec manager 545 is a component of the ASN gateway 520, the IPsec manager 545 can return the IPsec symmetric key 550 to the calling or controlling component of the ASN gateway 520.

Either during or after the IPsec manager's 545 generation of the IPsec symmetric key 550, the ASN gateway 520 can instruct the IPsec agent 510 of the mobile subscriber device 505 to perform its independent generation of the IPsec symmetric key 550. From that point forward, the ASN gateway 520 can utilize the IPsec symmetric key 550 to establish IPsec security associations used to secure network communications 565 exchanged with the mobile subscriber device 505.

As used herein, the presented security association database 555 can be a physical or virtual storage space configured to store digital information. The security association database 555 can be physically implemented within any type of hardware including, but not limited to, a magnetic disk, an optical disk, a semiconductor memory, a digitally encoded plastic memory, a holographic memory, or any other recording medium. The security association database 555 can be a stand-alone storage unit as well as a storage unit formed from a plurality of physical devices. Additionally, information can be stored within security association database 555 in a variety of manners. Further, security association database 555 can utilize one or more encryption mechanisms to protect stored information from unauthorized access.

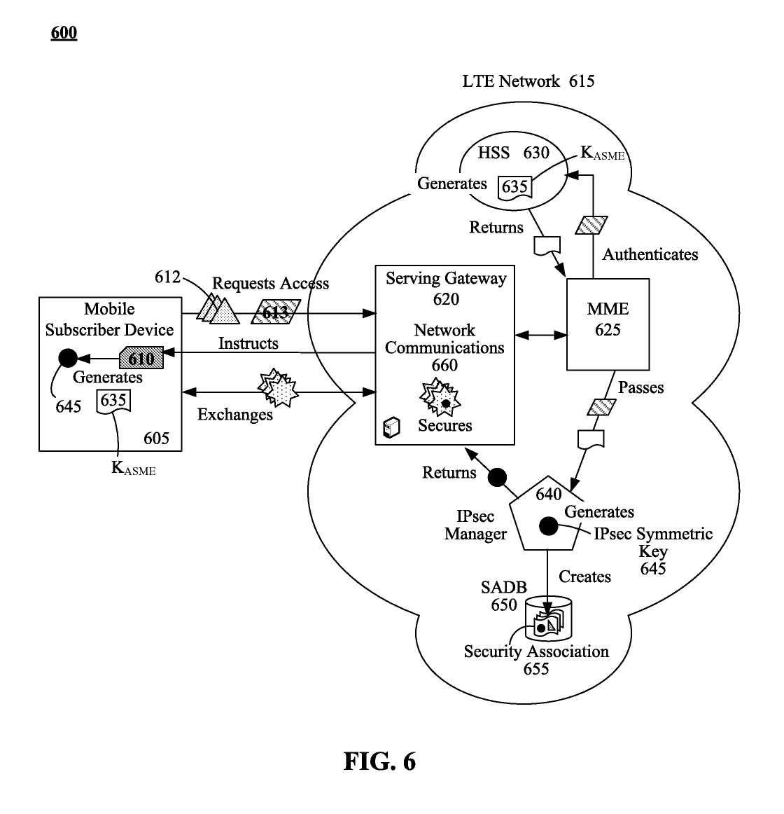

FIG. 6 shows an illustrated process flow 600 depicting generation of the IPsec symmetric key 645 in a LTE network 615 in accordance with embodiments of the inventive arrangements disclosed herein. The steps of process flow 600 can be performed within the context of systems 100, 200, and/or in conjunction with method 400.

Process flow 600 can begin when the mobile subscriber device 605 requests access to the LTE network 615. As part of requesting access, the mobile subscriber device 605 can exchange a series of entry messages 612 with the serving gateway 620 as well as provide the serving gateway 620 with authentication data 513.

The serving gateway 620 can pass the authentication data 513 to the MME 625 to initiate authentication of the mobile subscriber device 605. The MME 625 can request authentication of the mobile subscriber device 605 from the HSS 630. Upon successful authentication of the mobile subscriber device 605 by HSS 630, the HSS 630 can generate the K_{ASME} 635 to be used for the mobile subscriber device 605.

The HSS 630 can return the K_{ASME} 635 to the MME 625, which, in turn, passes the K_{ASME} 635 can to the IPsec manager 640. Additionally, the MME 625 or serving gateway 620 can also pass the authentication data 613 to the IPsec manager 640 at this time. Alternately, the IPsec manager 640 can request the authentication data 613 or a unique identifier for the mobile subscriber device 605 from the serving gateway 620.

Using the K_{ASME} 635, the IPsec manager 640 can generate the IPsec symmetric key 645. The following equation can exemplify generation of the IPsec symmetric key (ISK) 645:

ISK=HMAC-SHA-256(Key,S),

where HMAC-SHA-256 is a key generating function using a secure hash algorithm; Key represents the primary security key shared between the mobile subscriber device and the wireless communications network; and S is an input string derived from the unique identifier of the mobile subscriber device. Specifics of the above algorithm can vary from implementation-to-implementation and derivatives and alternatives are contemplated.

As shown, the equation can utilize the HMAC-SHA-256 key generation algorithm that utilizes a 256-bit secure hash algorithm. The parameters to this key generation algorithm can include input key material, Key, and an input string for altering output, S. The K_{ASME} 635 can be used as the input key material.

The output altering string, S, can act like the seed value of a random number generating function; it can provide a means for interjecting a second layer of variability into the function to enhance the strength of the cryptography. The output altering string, S, can be dynamically generated on a per-device basis using the following variables and equation:
FC=0xFF P₀=IMSI L₀=IMSI length

S=Offset|P₀|L₀

As shown in this example, S can be the concatenation of parameters—FC, P₀, and L₀. The FC parameter can represent a single octet used to distinguish between different instances of the algorithm. The P₀ parameter can represent the value of the International Mobile Subscriber Identity (IMSI), typically a fourteen to fifteen digit number stored on a SIM card. The L₀ parameter can represent the length of the IMSI value.

Similar to the function illustrated in process flow 500, use of the IMSI value and its length can provide additional variation of the IPsec symmetric key 645 on a per device 505 basis.

After generation of the IPsec symmetric key 645, the IPsec manager 640 can create the security association 655 for the mobile subscriber device 605 in the security association database (SADB) 650. Then, the IPsec manager 640 can return the IPsec symmetric key 645 to the serving gateway 620.

In an alternate embodiment where the IPsec manager 640 is a component of the serving gateway 620, the IPsec manager 640 can return the IPsec symmetric key 645 to the calling or controlling component of the serving gateway 620.

Parallel to the IPsec Symmetric Key generation at the network side as described above, the mobile subscriber device 605 independently can generate the same IPsec Symmetric Key 645 using the K_{ASME} 635 and the same algorithm as defined in [0087]-[0090]. If the mobile subscriber device 605 doesn't automatically generate the IPsec Symmetric Key 645, either during or after the IPsec manager's 640 generation of the IPsec symmetric key 645, the serving gateway 620 can instruct the IPsec agent 610 of the mobile subscriber device 605 to perform its independent generation of the IPsec symmetric key 645. From that point forward, the serving gateway 620 can utilize the IPsec symmetric key 645 to establish IPsec security associations to secure network communications 660 exchanged with the mobile subscriber device 605.

As used herein, the presented security association database 655 can be a physical or virtual storage space configured to store digital information. The security association database 655 can be physically implemented within any type of hardware including, but not limited to, a magnetic disk, an optical disk, a semiconductor memory, a digitally encoded plastic memory, a holographic memory, or any other recording medium. The security association database 655 can be a stand-alone storage unit as well as a storage unit formed from a plurality of physical devices. Additionally, information can be stored within security association database 655 in a variety of manners. Further, security association database 655 can utilize one or more encryption mechanisms to protect stored information from unauthorized access.

This invention can be embodied in other forms without departing from the spirit or essential attributes thereof. Numerous modifications and equivalent circuits will occur to those skilled in the art upon reading and understanding the teachings herein. Accordingly, reference should be made to the following claims, rather than to the foregoing specification, as indicating the scope of the invention.

What is claimed is:

1. A method for securing wireless network communications comprising:
authenticating of a mobile subscriber device by an access router of a wireless communications network, wherein said wireless communications network supports standards and protocols associated with an Internet Protocol (IP) of at least version six, wherein the access router acts as a gateway for exchanges of network communications between the mobile subscriber device and the wireless communications network;
upon successful authentication of the mobile subscriber device to the wireless communications network, establishing a security association between the mobile subscriber device and the access router, wherein said security association utilizes a dynamically-generated IP security (IPsec) symmetric key unique to the mobile subscriber device; and
securing of subsequent network communications between the mobile subscriber device and the access router, wherein the IPsec symmetric key is either used to authenticate and encrypt/decrypt said subsequent network communications or used to dynamically establish further IPsec security associations to authenticate and encrypt/decrypt said subsequent network communications, wherein said securing is performed as at least one of a substitute for existing security measures of the wireless communications network and an additional security measure for existing security measures of the wireless communications network.

2. The method of claim 1, wherein establishing of the security association further comprises:
receiving of a primary security key by an IPsec manager, wherein said primary security key was generated by the wireless communications network as a result of the successful authentication of the mobile subscriber device, wherein said primary security key is unique for a communications session between the mobile subscriber device and the wireless communications network;
dynamically generating the IPsec symmetric key from the primary security key, wherein said generation is performed in accordance with standard key generation algorithms and protocols;
obtaining a unique identifier associated with the mobile subscriber device; and
recording a relationship between the obtained unique identifier and the generated IPsec symmetric key as the security association in a security association database.

3. The method of claim 2, wherein the IPsec symmetric key is generated in accordance with at least one of an Internet Key Exchange (IKE) protocol, an Internet Security Association and Key Management protocol (ISAKMP), a Kerberized Internet Negotiation of Keys (KINK) protocol, and a use of IPSECKEY DNS records.

4. The method of claim 3, wherein, when the wireless communications network is a Worldwide Interoperability for Microwave Access (WiMax) network, said IPsec symmetric key (ISK) is generated using
ISK=Dot16KDF(SUBSTR(MSK,320,192),MAC Address|“IKE”,192),
wherein Dot16KDF is a key generation algorithm, SUBSTR(MSK,320,192) defines input key material as a substring of a Master Session Key (MSK) starting at a character located at place 320 for a length of 192 characters, MAC Address is a unique Media Access Control (MAC) identifier of the mobile subscriber device, MAC Address|“IKE” represent a string for altering output of the key generation algorithm, and 192 define a length of the IPsec symmetric key to be generated by the key generation algorithm.

5. The method of claim 3, wherein, when the wireless communications network is a Long Term Evolution (LTE) network, said IPsec symmetric key (ISK) is generated using
ISK=HMAC-SHA-256(Key,S),
wherein HMAC-SHA-256 is a key generating function using a secure hash algorithm, Key represents the primary security key shared between the mobile subscriber device and the wireless communications network, and S is an input string derived from the unique identifier of the mobile subscriber device.

6. The method of claim 2, wherein, when the wireless communications network is a WiMax network, a Master Session key is used as the primary security key.

7. The method of claim 2, wherein, when the wireless communications network is a LTE network, K_{ASME} is used as the primary security key.

8. The method of claim 2, wherein the unique identifier of the mobile subscriber device is a Media Access Control (MAC) address.

9. The method of claim 1, further comprising:
instructing of the mobile subscriber device by the access router to independently generate the IPsec symmetric key, wherein said generation by the mobile subscriber device is performed in a manner identical to that performed by the wireless communications network, wherein said independent generation of the IPsec symmetric key increases security of exchanged network communications by eliminating distribution of the IPsec symmetric key and possible interception of the IPsec symmetric key by an unauthorized entity.

10. The method of claim 1, wherein a change in a physical location of the mobile subscriber device requires use of a second access router of the wireless communications network, said method further comprising:
transferring of ownership of the security association for the mobile subscriber device from the access router to the second access router, wherein service to the mobile subscriber device is unaffected by said transference.

11. A system for securing wireless network communications comprising:
a mobile subscriber device capable of handling Internet Protocol security (IPsec)-secured network communications;
a wireless communications network configured to exchange IPsec-secured communications with the mobile subscriber device, said wireless communications network comprising:
a set of authentication handling components configured to ascertain a connectivity validity for the mobile subscriber device to access the wireless communications network;
an access router configured to act as a gateway to the wireless communications network for exchanging IP security-secured network communications with the mobile subscriber device having valid connectivity as ascertained by the set of authentication handling components; and
an Internet Protocol security (IPsec) manager configured to dynamically establish a unique security association between the mobile subscriber device and the access router, wherein said security association is used to secure network communications with the mobile subscriber device, creating said IPsec-secured network communications.

12. The system of claim 11, wherein the set of authentication handling components is configured to generate a primary security key for a communications session associated with the mobile subscriber device when the mobile subscriber device is successfully authenticated to the wireless communications network.

13. The system of claim 12, wherein the IPsec manager generates an IPsec symmetric key from the primary security key, wherein said IPsec symmetric key is used as part of the security association for the mobile subscriber device, and, wherein generation of the IPsec symmetric key is performed in accordance with at least one of an Internet Key Exchange (IKE) protocol, an Internet Security Association and Key Management protocol (ISAKMP), a Kerberized Internet Negotiation of Keys (KINK) protocol, and a use of IPSECKEY DNS records.

14. The system of claim 12, wherein, when the wireless communications network is a WiMax network, a Master Session key is used as the primary security key.

15. The system of claim 12, wherein, when the wireless communications network is a LTE network, K_{ASME} is used as the primary security key.

16. The system of claim 11, further comprising:
a security associations database configured to store a plurality of security associations for a plurality of mobile subscriber devices, wherein a one-to-one relationship exists between a stored security association and an active mobile subscriber device, wherein the stored security association for the mobile subscriber device is removed from the security associations database once the mobile subscriber device disconnects from the wireless communications network.

17. A computer program product comprising a computer readable storage medium having computer usable program code embodied therewith, the computer usable program code comprising:
computer usable program code configured to acquire a primary security key generated by authentication handling components of a wireless communications network upon successful authentication of a mobile subscriber device, wherein said primary security key is unique for a communications session between the mobile subscriber device and the wireless communications network;
computer usable program code configured to dynamically generate an Internet Protocol security (IPsec) symmetric key from the primary security key, wherein said generation is performed in accordance with standard key generation algorithms and protocols;
computer usable program code configured to obtain a unique identifier associated with the mobile subscriber device; and
computer usable program code configured to record a relationship between the obtained unique identifier and the generated IPsec symmetric key as a security association in a security association database of the wireless communications network, wherein said security association is used to secure network communications between the wireless communications network and the mobile subscriber device.

18. The computer program product of claim 17, wherein, when the wireless communications network is a Worldwide Interoperability for Microwave Access (WiMax) network, said IPsec symmetric key (ISK) is generated using
ISK=Dot16KDF(SUBSTR(MSK,320,192),MAC Address|“IKE”,192),
wherein Dot16KDF is a key generation algorithm, SUBSTR(MSK,320,192) defines input key material as a substring of a Master Session Key (MSK) starting at a character located at place 320 for a length of 192 characters, MAC Address is a unique Media Access Control (MAC) identifier of the mobile subscriber device, MAC Address|“IKE” represent a string for altering output of the key generation algorithm, and 192 define a length of the IPsec symmetric key to be generated by the key generation algorithm.

19. The computer program product of claim 17, wherein, when the wireless communications network is a Long Term Evolution (LTE) network, said IPsec symmetric key (ISK) is generated using
ISK=HMAC-SHA-256(Key,S),
wherein HMAC-SHA-256 is a key generating function using a secure hash algorithm, Key represents the primary security key shared between the mobile subscriber device and the wireless communications network, and S is an input string derived from the unique identifier of the mobile subscriber device.

20. The computer program product of claim 17, wherein the unique identifier of the mobile subscriber device is a Media Access Control (MAC) address.
